(19) United States
(12) Patent Application Publication
(10) Pub. No.: US 2015/0081518 A1
(43) Pub. Date: Mar. 19, 2015

(54) SYSTEMS AND METHODS FOR AUTOMATED WAGE ASSIGNMENTS

(71) Applicant: Cash Source Group, LLC, Springville, UT (US)

(72) Inventor: Blake Collins, Cedar Hills, UT (US)

(73) Assignee: Cash Source Group, LLC, Springville, UT (US)

(21) Appl. No.: 14/152,854

(22) Filed: Jan. 10, 2014

Related U.S. Application Data
(60) Provisional application No. 61/880,119, filed on Sep. 19, 2013.

(51) Int. Cl. G06Q 40/02

(52) U.S. Cl. CPC G06Q 40/025
USPC 705/38

(57) ABSTRACT

A method for automated wage assignments is described. A wage assignment compliance level is obtained from an entity. The wage assignment compliance level is stored in a database. The wage assignment compliance level is recalled from the database in response to a request. A response to the request is sent indicating the wage assignment compliance level of the entity.

### CROSS REFERENCE TO RELATED APPLICATIONS

This application claims priority to and the benefit of U.S. Provisional Application No. 61/880,119 filed Sep. 19, 2013, the entire content of which is hereby incorporated by reference in its entirety.

### TECHNICAL FIELD

The present disclosure relates generally to computers and computer-related technology. More specifically, the present disclosure relates to systems and methods for automated wage assignments and reducing lending risk based on wage assignments.

### BACKGROUND

Computing technology continues to advance rapidly. Indeed, computers are involved in many aspects of a person's everyday activities. Commonly used computers include everything from hand-held computing devices to large multi-processor computer systems.

Computers are used in almost all aspects of business, industry, and academic endeavors. More and more homes are also using computers. The pervasiveness of computers has been accelerated by the increased use of computer networks, including the Internet. On a computer network, one or more servers may provide data, services, and/or may be responsible for managing other computers. A computer network may include hundreds or even thousands of computers.

Most companies have one or more computer networks and also make extensive use of the Internet. The productivity of employees often depends upon human computer interaction. Improvements in computers and software have been a force for bringing about great increases in business and industrial productivity especially in the financial lending environment.

### BRIEF DESCRIPTION OF THE DRAWINGS

FIG. 1 is a block diagram illustrating one configuration of a system for employing automated wage assignments;

FIG. 2 is a call-flow diagram illustrating a configuration for employing automated wage assignments;

FIG. 3 is a block diagram illustrating a detailed configuration of a system for employing automated wage assignments;

FIG. 4 is a flow diagram illustrating a method for creating a wage assignment on an electronic device;

FIG. 5 is a flow diagram illustrating a method for receiving a wage assignment request on an electronic device;

FIG. 6 is a flow diagram illustrating a method for recording data in association with a wage assignment agreement on an electronic device;

FIG. 7 is a flow diagram illustrating a method for employing automated wage assignments on an electronic device;

FIG. 8 is a flow diagram illustrating a method for associating a borrower with employers;

FIG. 9 is a flow diagram illustrating a method for assessing lead information using wage assignments; and

FIG. 10 illustrates various components that may be utilized in an administrative system and/or client.

### DETAILED DESCRIPTION

Lending companies, such as microlenders, continually weigh and analyze data to calculate lending risk. In microlending, lending risk is high because loans are issued with little or no collateral and, as a result, such loans typically involve high interest rates. In such environments, determining which borrowers (e.g., customers, consumers, or debtors) are less of a financial risk can be difficult. Even the best analytical data sourcing and methodologies cannot always predict which borrowers will default on a loan. In many instances, it is not a question of if the borrowers will default on a loan, but when.

Accordingly, the systems and methods disclosed herein allow for employing automated wage assignments and reducing lending risk in such environments. Lending may include microlending cash to a borrower and/or extending services and memberships. For example, a health club may extend membership on credit. In some cases, the system and methods disclosed herein allow a collateral based lending company to obtain repayment for a loan before attempting to sell the collateral, or repossess the collateral from the borrower, if it is in the borrower's possession. For example, a car salesman generally prefers to be repaid for a sold car rather than incurring the costs and risks of repossessing the car.

A wage assignment is a legal instrument that allows a borrower to voluntarily assign or transfer payment from the borrower's future paycheck to a lending agent. A wage assignment is not a garnishment, in which a creditor obtains an order from a court to collect part of the borrower's wages from the borrower's employer. Wage assignments may be governed by statutes in most states, or by federal law.

By employing the system and methods described herein, a borrower's risk can be assessed without the need to check the borrower's credit score or inquire into the borrower's financial history. Thus, by employing a wage assignment agreement, a loan issued to a customer may be collateralized. For example, the borrower's employer may be able to repay the loan from the borrower's earnings through the use of a wage assignment, thereby avoiding a formal garnishment process and/or other costly legal proceedings. Further, the system and methods may help reduce lending risk in a financial environment by allowing lenders to obtain more accurate risk assessments when lending to customers.

Various configurations of the systems and methods are now described with reference to the figures, where like reference numbers may indicate identical or functionally similar elements. The configurations of the present systems and methods, as generally described and illustrated in the figures herein, could be arranged and designed in a wide variety of different configurations. Thus, the following more detailed description of several configurations, as represented in the figures, is not intended to limit the scope of the systems and methods as claimed, but is merely representative of the various configurations of the systems and methods.

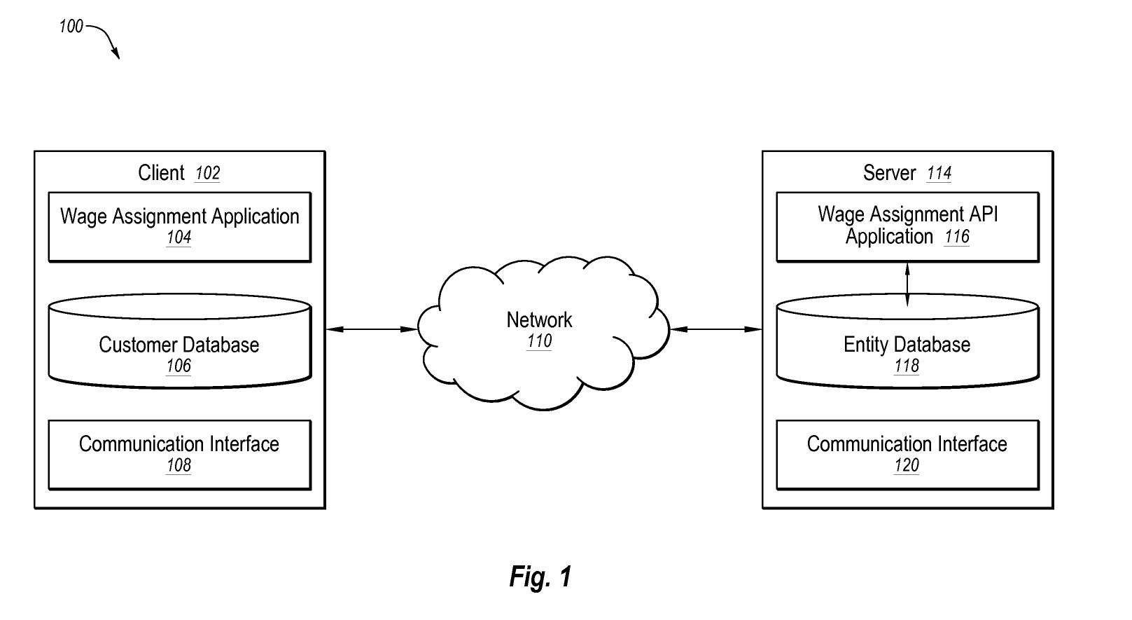

FIG. 1 is a block diagram illustrating one configuration of a system 100 for employing automated wage assignments. The system 100 may include one or more clients 102, one or more servers 114, and a network 110. Examples of the client 102 and/or server 114 include desktop computers, laptop computers, supercomputers, smartphones, tablet devices, game consoles, e-readers, and/or other devices that include memory, a processor, and a communications interface.

The server 114 may include a wage assignment API application 116, an entity database 118, and a communication interface 120. The server 114 may be located on a single device or part of a system composed of multiple servers. In some configurations, the wage assignment API application 116 may be a module. As used herein, a “module” may be implemented in hardware, software, or a combination of both. For example, the wage assignment API application 116 may be a wage assignment API application module that is implemented in hardware, software, or a combination of hardware and software.

The wage assignment API application 116 on the server 114 may receive communications from the client 102 such as requests, pings, inquiries, and/or calls. For example, the wage assignment API application 116 may receive an application programming interface (API) call from the client 102.

The wage assignment API application 116 may be in communication with the entity database 118 when processing communications from the client 102. For example, in response to a communication from the client 102, the wage assignment API application 116 may access, create, verify, process, query, combine, update, and/or remove records to/from the entity database 118. It should be noted that the terms wage assignment, wage agreement, and wage assignment agreement may be used interchangeably herein.

The entity database 118 may include entries and/or records of entities and/or employers. While the terms “entity” and “employer” are often used interchangeable herein, an employer is one example of an entity. Other examples of entities may include a person, a corporation, a cooperative, a partnership, etc. Further, as used herein, the term “borrower” may refer to a customer, consumer, debtor, or any other person or unit seeking a loan. The term “lending agent” may refer to a lender, microlender, loan officer, credit agent, or other individual issuing a loan to a borrower.

In some configurations, a unique key identifier may identify each record in the entity database 118. Each record may be associated with an entity and may indicate if a wage assignment compliance request has been sent to the entity. Further, each record may indicate whether the entity has responded along with the entity's response, such as if the entity indicated compliance or non-compliance. For example, a record in the employer database 118 may indicate that an employer has responded positively and/or has previous honored a wage assignment agreement. As another example, a record may indicate that an employer has specified that they will not honor a wage assignment agreement and/or has refused to honor a previous wage assignment agreement. In this case, the record may indicate that a court order is required before collecting a borrower's wages from the employer. Thus, the record may indicate the wage assignment compliance level of the entity.

Multiple borrowers may share a common entity or employer. Therefore, once an entity's information is in the entity database 118, a client 102 may quickly ascertain whether an entity is in the entity database 118 and whether the entity will comply or honor a wage assignment agreement.

If the entity will honor a wage assignment agreement, then the lending agent is able to collateralize a loan issued to a borrower, thereby reducing lending risk. In this manner, a lending agent is better able to serve potential borrowers without performing a credit check or performing other types of credit history verification.

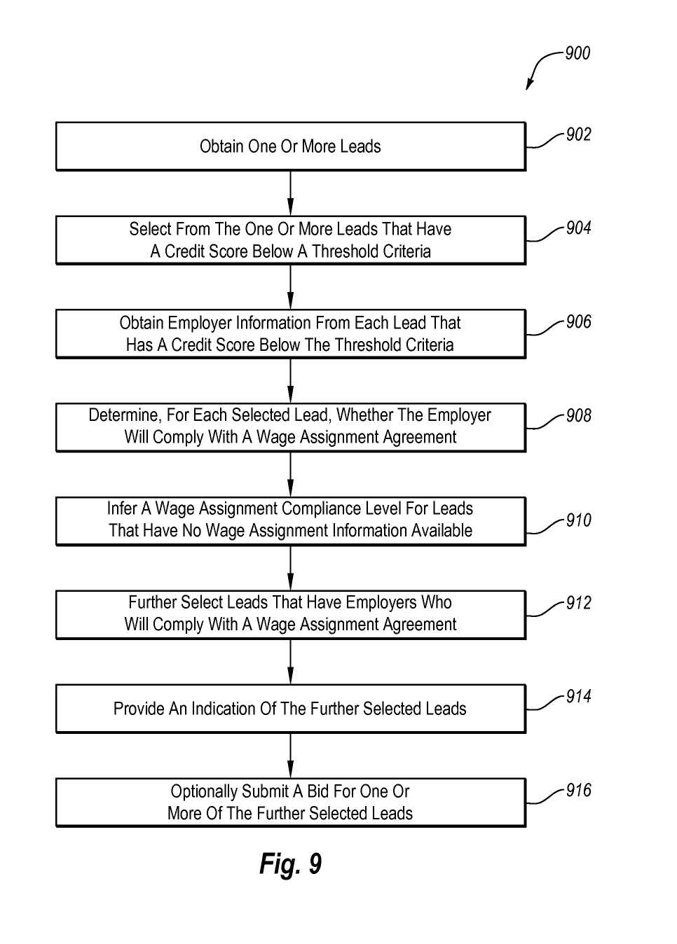

In some configurations, as described below, the wage assignment compliance level of an entity may be inferred based on the wage assignment compliance level of related entities. For example, an entity may be inferred to have the same wage assignment compliance level as its related parent entity. Further detail regarding inferring wage assignment compliance levels is described below in connection with FIG. 9.

The communication interface 120 may connect the server 114 to the network 110. For example, the network 110 may be a local area network (LAN), wireless LAN (WLAN), municipal area network (MAN), wide area network (WAN), the Internet, plain old telephone service (POTS), etc.

One or more clients 102 may be connected to the server 114 via the network 110. The client 102 may be owned and/or operated by the same entity that owns and/or operates the server 114. In some cases, a third party may operate the client 102. In some configurations, the server 114 and the client 102 may be connected using a secure connection via the network 110. In another configuration, the server 114 and the client 102 may communicate via a direct connection. In other configurations, the server 114 and the client 102 may be combined together into a device without the need of the network 110.

Each client 102 may include a wage assignment agent 104, a customer database 106 or borrower database, and a communication interface 108. The wage assignment agent 104 may be software installed on the client 102. In some configurations, the wage assignment agent 102 may include one or more agent modules. The wage assignment agent 104 may make API calls to the server 114. For example, the wage assignment agent 104 may make API calls to the wage assignment API application 116 located on the server 114.

In some configurations, the wage assignment agent 104 may include various applications loaded on the client 102. Each agent application may enable an area of functionality that is implemented by the one or more applications.

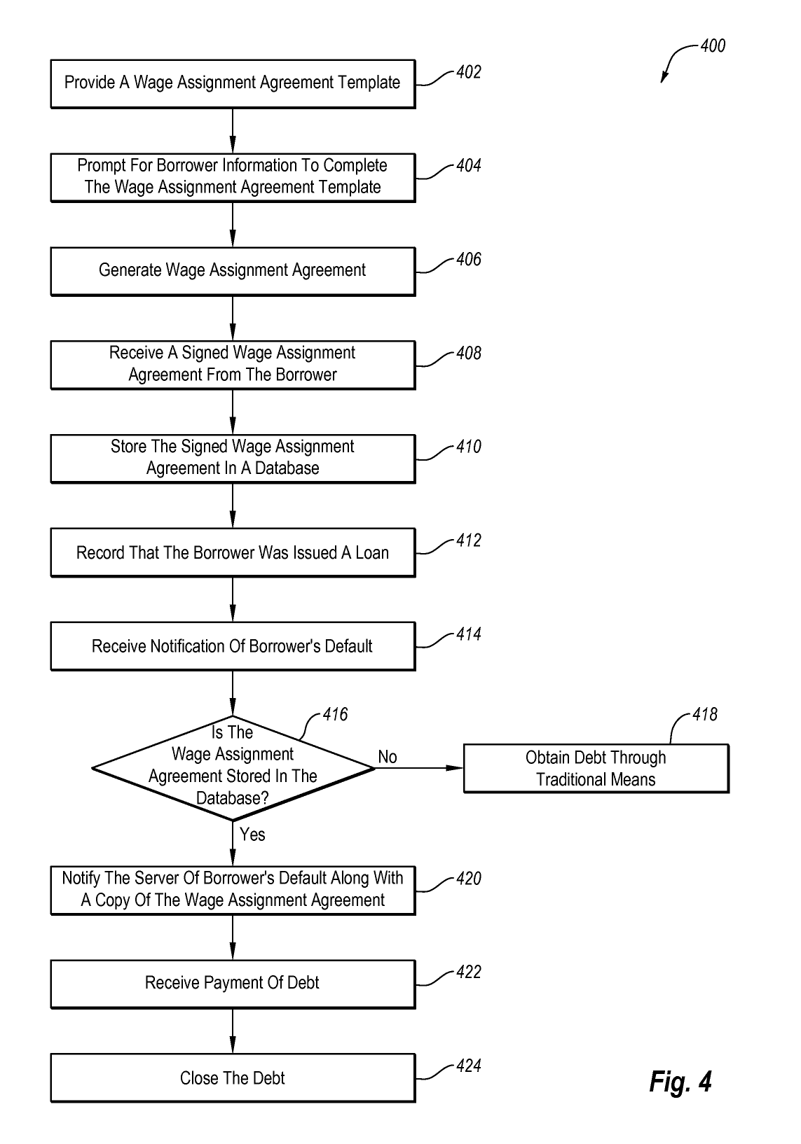

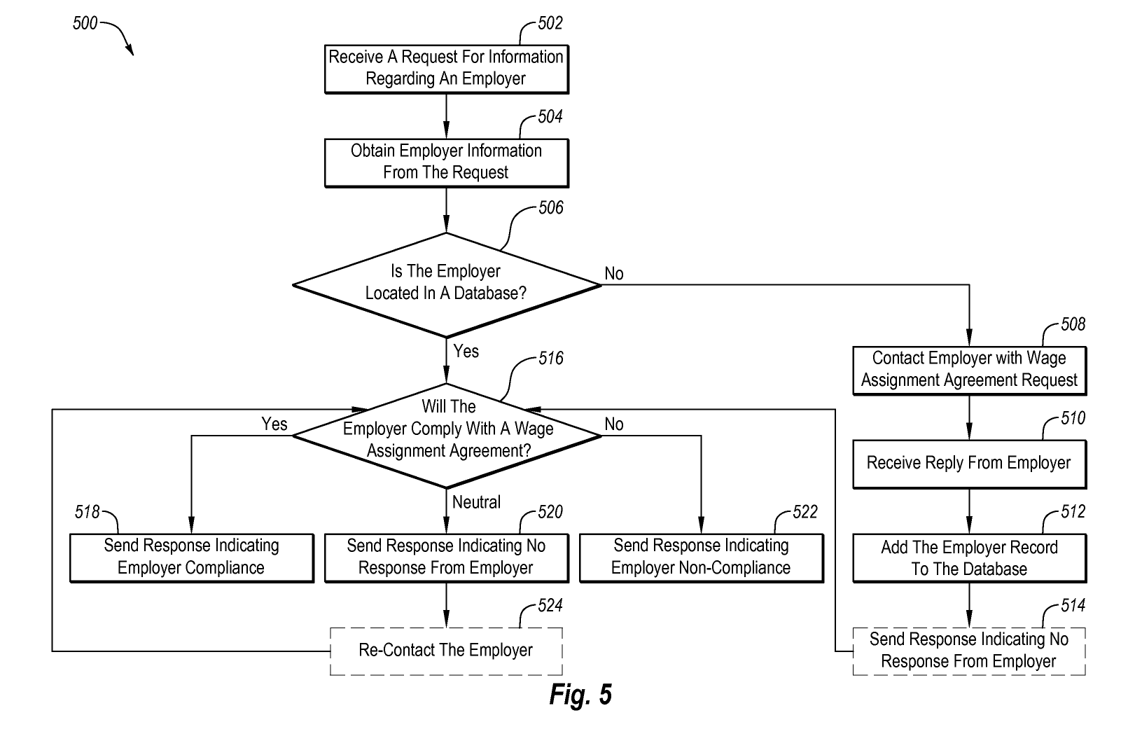

The wage assignment agent 104 may assist a user to create wage assignment agreements. A user may be a lending agent, loan officer, credit agent, etc., or other person who operates the client 102. The wage assignment agent 104 may also assist a user in sending requests to the server 114 to inquire if a borrower's entity or employer will comply with a wage assignment agreement. Additional detail regarding creating wage assignment agreements and sending requests to the server 114 will be discussed below in connection with FIGS. 4 and 5.

The customer database 106 may include records or entries of borrowers (e.g., customers). A borrower's record may include biographical data, contact information, address information, loan information, etc. The borrower's record may also include the borrower's employer along with corresponding employment information. Further, the borrower's record may include wage assignment agreements the borrower may have made. The customer database 106 may also include potential leads and lead information.

The communication interface 108 may be similar to the communication interface 120 described above. For example, the communication interface 108 may be employed to send and receive communications over the network 110 to and from the server 114, or other electronic devices.

The system and methods described herein enable for risk to be reduced when lending credit to borrowers because the credit loan is secured with the collateral of a wage assignment agreement. Further, legal costs of collecting on loan payments are reduced because lending agents and collectors do not need to track down borrowers for payment. In addition, accounts of borrowers in default do not need to be sold off or otherwise transferred to collection agencies. Rather, the borrower's employer can pay the debt owed from the borrower's future paychecks.

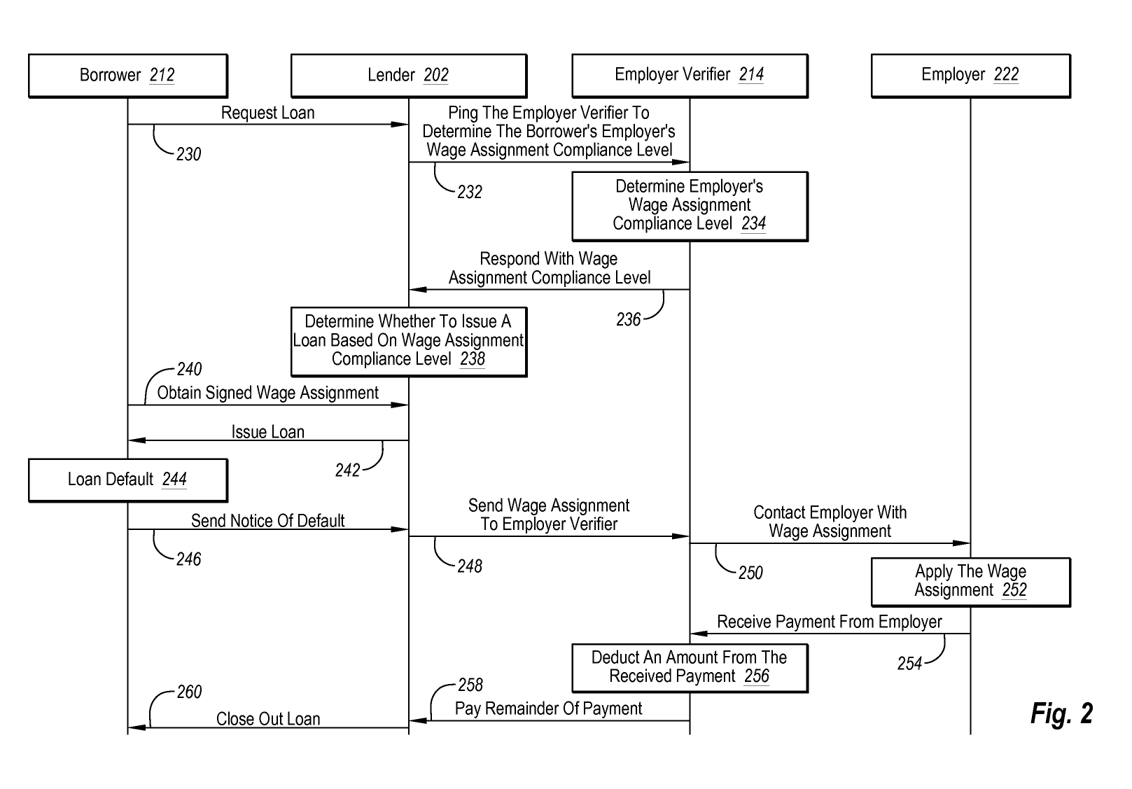

FIG. 2 is a call-flow diagram illustrating a configuration for employing automated wage assignments. The configuration may include a borrower 212, a lender 202, an employer verifier 214, and an employer 222.

The borrower 212 may be a customer seeking to obtain a loan or credit from the lender 202. The borrower 212 may be an employee of the employer 222. The borrower 212 may also be a lead. Leads will be discussed below in connection with FIG. 9.

The lender 202 may be one configuration of the client 102 discussed in connection with FIG. 1. The lender 202 may be an electronic device operated by a sub-prime money-lending agent, such as a payday lender. In some instances, the lender 202 may be operated by an issuer of memberships, such as a golf course, athletic or other type club, fitness center, etc. The lender 202 may also be used in association with a rent-to-own merchant, car dealership, installment loan agency, or any other type of credit lender that provides credit, loans, or services to borrowers, particularly in the sub-prime markets.

The employer verifier 214 may be one configuration of the server 114 discussed in connection with FIG. 1 above. For example, the employer verifier 214 may store and recall records indicating the wage assignment compliance level of a specific employer or entity.

The employer 222 may be an entity, as discussed above, and may employ a number of employees. In some configurations, one employee of the employer may be the borrower 212.

As illustrated in FIG. 2, the borrower 212 may request 230 a loan from the lender 202. For example, the borrower 212 may contact the lender 202 and request a loan. In some instances, the borrower 212 may be contacted by the lender 202 regarding a loan after the borrower 212 has expressed an interest in obtaining a loan. For example, the borrower 212 may fill out a loan application online (e.g., through a website, via email, etc.) and the lender 202 may respond to the loan application. As another example, the borrower 212 may physically enter into a payday lender establishment associated with the lender 202 to obtain a loan.

Upon establishing communication with the borrower 212, the lender 202 may obtain information about the borrower, such as biographical information, personal information, financial information, employment information, etc. If the borrower 212 is employed, the borrower 212 may be able to obtain a loan without being subject to traditional credit checks, or the borrower 212 may be able to obtain a loan even if the borrower's credit score is sub-par.

Using the borrower's employment information, the lender 202 may ping 232 the employer verifier 214 to determine the wage assignment compliance level of the borrower's employer 222. In other words, the lender 202 may request the wage assignment compliance level of the employer 222 from the employer verifier 214.

The employer verifier 214 may determine 234 the wage assignment compliance level for the borrower's employer. The employer verifier 214 may recall this data from an entity database 118, or may request the wage assignment compliance level from the employer 222 if such information is not stored in the entity database 118. In some configurations, if no information regarding the employer 222 is stored in the entity database 118, the employer verifier 214 may respond that no record exists. The employer verifier 214 may also record the number of times the wage assignment compliance level for that employer 222 has been requested. If the employer number of requests meets or exceeds a threshold, the employer verifier 214 may contact the employer 222 to determine the wage assignment compliance level of the employer 222.

The employer verifier 214 may respond 236 to the ping request with the wage assignment compliance level of the employer 222. The wage assignment compliance level may specify if the employer 222 is compliant or non-compliant with respect to wage assignment agreements. In some instances, the wage assignment compliance level may verify that the employer 222 has previously repaid a borrower's debt by honoring a previous wage assignment agreement. In other cases, the wage assignment compliance level may specify the probability (e.g., confidence level) or a probability range that the employer 222 will honor and apply the wage assignment.

The lender 202 may determine 238 whether to issue a loan or extend credit based on the received wage assignment compliance level. For example, if the wage assignment compliance level specifies that the employer 222 has previously honored wage assignments by repaying other lenders, the lender 202 may decide to issue a loan to the borrower 212. The wage assignment compliance level may also factor into the amount of a loan to issue to the borrower 212. Alternatively, the lender 202 may not issue a loan to the borrower 212 based on the received wage assignment compliance level. In this case, the lender 202 may determine to issue a loan to the borrower 212 based on traditional factors, such as the borrower's credit score. For example, the electronic device may indicate to the lender 202 to perform a credit inquiry or other background investigation of the borrower 212. A credit inquiry may include the financial history of the borrower 212, such as the borrower's payments of previous bills, if the borrower 212 owns or rents their residence, etc.

Before issuing a loan, the lender 202 may obtain 240 a signed wage assignment from the borrower 212. The lender 202 may store the signed wage assignment in the customer database 106. For example, the wage assignment may be uploaded as a PDF (portable document format) file and stored by the lender 202. As another example, the wage assignment may be uploaded as an HTML form submission that is stored by the lender 202. As a further example, the wage assignment may be submitted using a Java applet, Java servlet, or similar technology. After receiving and storing the signed wage assignment, the lender 202 may issue 242 a loan to the borrower 212. For example,

The borrower 212 may subsequently default 244 on the loan. The lender 202 may receive 246 a notice of the default. For example, the borrower 212 may inform the lender 202 of the default, or the borrower 212 may fail to meet a payment deadline.

The lender 202 may recall the wage assignment, for example, from the customer database 106. The lender 202 may send 248 the wage assignment to the employer verifier 214. The employer verifier 214 may contact 250 the employer 222 with the wage assignment agreement. For example, the employer verifier 214 may send an electronic message such as a fax, email, text message, or combination thereof, to the employer 222. In some configurations, the wage assignment API application may send a document package to the employer 222 directly, or via a third party. For instance, the employer verifier 214 may send the document package to the third party via email. Then, the third party may fax the document package to the employer 222. In this configuration, additional software configuration may be required.

The document package may include documents such as a confidentiality notice, a wage assignment demand notice, a calculation worksheet, employment confirmation, the signed and executed wage assignment agreement of the borrower 212, etc. The document package may also include the lender's 202 address information or other contact information where the employer 222 can send a check or payment to the lender 202.

The wage demand notice may inform the employer 222 that the borrower 212 owes a debt to lender 202, the total amount of debt under the loan agreement, when the employer 222 is to deduct wages from the borrower 212, that the borrower 212 has received prior notice of the wage assignment demand being served to the employer 222, etc.

The calculation worksheet may provide guidelines for deducting wages from the borrower's 212 wages. For example, the calculation worksheet may instruct the employer 222 to deduct the lesser of (a) 15% of the borrower's disposable pay (not to exceed 15%) or (b) 25% of the borrower's disposable pay, less the amounts withheld under the withholding with priority. Additionally and/or alternatively, the calculation worksheet may provide a link to the employer 222 that automatically calculates the deduction amount for the employer 222 or otherwise provides further guidelines and information to the employer 222 regarding how to process the wage assignment.

The employment confirmation may be used to verify that the borrower 222 is a current employee. If the borrower 222 is no longer a current employee of the employer 222, the employer 222 may provide the borrower's last known contact information to the lender 202.

In response to receiving the wage assignment agreement, the employer 222 may apply 252 the wage assignment. For example, the employer 222 may deduct the owed amount from the borrower's paycheck. Alternatively, the employer 222 may deduct a portion of the owed amount up to a legal limit or deduct a portion of the owed amount as specified by the wage assignment agreement. In some instances, the employer 222 may deduct a portion of the owed amount from more than one of the borrower's paychecks.

The employer verifier 214 may receive 254 payment from the employer 222. Upon receiving payment, the employer verifier 214 may deduct 256 an amount from the received payment. The amount deducted from the received payment may be a percentage, flat rate, or fee agreed upon by the employer verifier 214 and the lender 202 for collecting the payment from the employer 222. The employer verifier 214 may then pay 258 the remainder of the payment to the lender 202. At this point, the lender 202 may closeout 260 the loan with the borrower 212. In some instances, for example, if the full amount of the owed amount is not repaid, the lender 202 may reduce the balance of the borrower's loan by the amount received from the employer verifier 214.

FIG. 2 illustrates one approach in which automated wage assignments may be employed. Additional approaches described below may be employed in conjunction with or in addition to the approach disclosed in connection with FIG. 2.

By employing the systems and methods disclosed herein, a user, such as a lending agent, may collateralize loans that are traditionally not collateralized. Further, the lending agent may achieve a higher repayment percentage from borrowers, thereby further reducing lending risk.

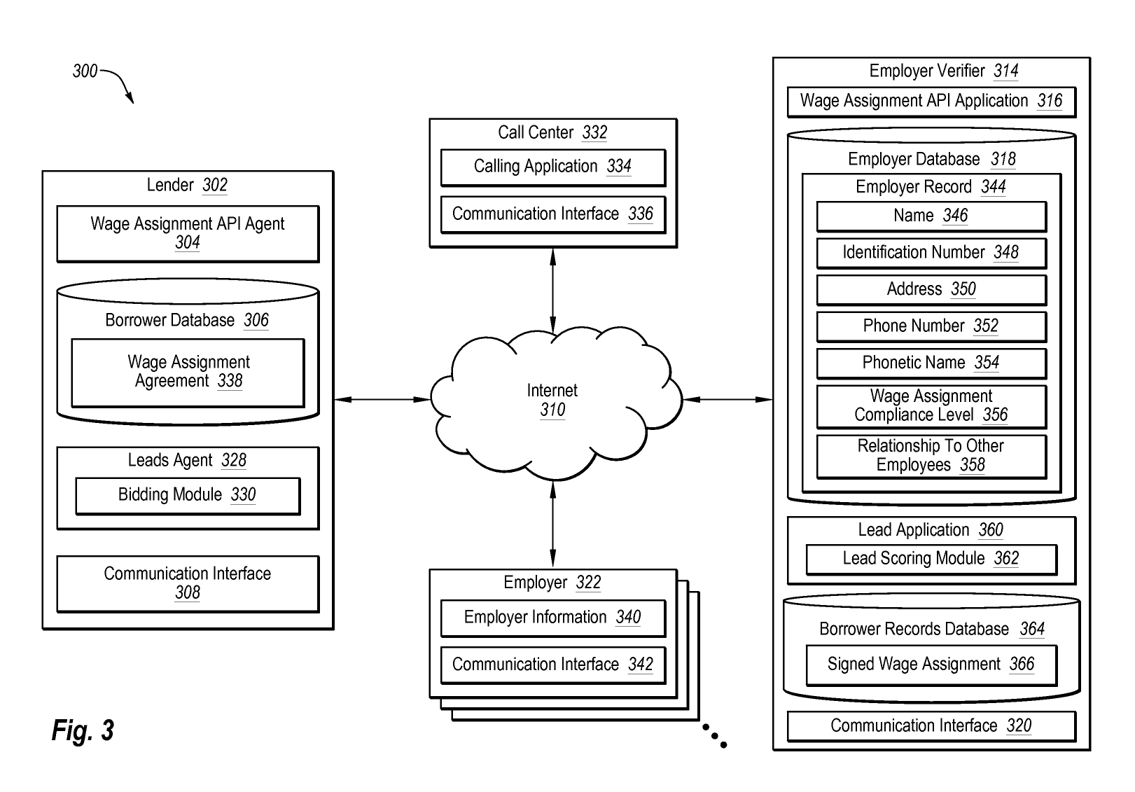

FIG. 3 is a block diagram illustrating a detailed configuration of a system 300 for employing automated wage assignments. In this configuration, the system 300 may include a lender 302, an employer verifier 314, a call center 332, an employer 322, and a network like the Internet 310.

The lender 302 may include a wage assignment API agent 304, a borrower database 306, a communication interface 308, and a leads agent 328. The lender 302 may be one configuration of the client 102 described above in connection with FIG. 1 and/or the lender 202 described in connection with FIG. 2. For example, the wage assignment API agent 304, borrower database 306, and communication interface 308 may be example configurations of the wage assignment agent 104, customer database 106, and communication interface 108, respectively.

In addition, the wage assignment API agent 304 may assist the lender 302 by making API calls and requests to the employer verifier 314. For example, the wage assignment API agent 304 may make one or more of the following API calls: employer inquiry, borrower or consumer add, borrower or consumer update, borrower or consumer view, loan add, loan update, loan view, report payment, payments view, document upload, or revoke wage assignment. The wage assignment API agent 304 may also use credentials to authenticate with the employer verifier 314 before API calls can be made. For example, the wage assignment API agent 304 may provide a lender identifier, username, and password to the employer verifier 314.

The wage assignment API agent 304 may also assist the lender 302 in creating, processing, and revoking wage assignment agreements. For example, the wage assignment API agent 304 may populate a wage assignment template with the borrower's information. Further the wage assignment API may communicate with the borrower database 306, which may store and recall a wage assignment agreement 338 signed by the borrower. The borrower database 306 may also record borrower information, such as biographical, personal, contact, financial, and/or employment information.

The lender 302 also includes a leads agent 328. A lead may indicate or represent a potential borrower that may qualify for a loan if certain criteria are satisfied. The leads agent 328 may include a bidding module 330. The leads agent 328 may communicate with the employer verifier 314 to identify which leads are promising candidates to extend loans to based on the wage assignment compliance level of their employers. Additional information regarding leads and bidding is described below in connection with FIG. 9.

The employer verifier 314 may include a wage assignment API application 316, an employer database 318, a communication interface 320, a leads application 360, and a borrower records database 364. The employer verifier 314 may be one configuration of the server 114 described above in connection with FIG. 1 and/or the employer verifier 214 described in connection with FIG. 2. For example, the wage assignment API application 316, employer database 318, and communication interface 320 may be exemplary configurations of the wage assignment API application 116, entity database 118, and communication interface 120, respectively.

Further, while illustrated on a single device, the employer verifier 314 may be divided up among a number of devices. For example, the lead application 360, the wage assignment API application 316, the employer database 318, and/or the borrower records database 364 may each be located on a separate electronic device. As another example, the borrower records database 364 may be located across multiple electronic devices.

The wage assignment API application 316 may assist the employer verifier 314 in communicating with the lender 302. For example, the wage assignment API application 316 may process requests from the wage assignment API agent 304 on the lender 302. For example, the wage assignment API application 316 may receive a hypertext transfer protocol (HTTP) form post from the wage assignment API agent 304. The HTTP posts may be sent securely, for example, using the secure socket layer (SSL) protocol. In some configurations, the wage assignment API application 316 may not process any requests that are not transmitted securely.

The wage assignment API application 316 may process the request and return a result. The returned result may include an inquiry number or inquiry identifier and a customer identifier for the lender 302 to store in connection with the request and reply. The result may be returned in a JavaScript object notation (JSON) format. Alternatively, the result may be returned in other formats, and/or through the use of any appropriate programming language, such as C, C++, C#, Java, JavaScript, Perl, Python, PHP, etc. In some configurations, requests may be sent in a URL call sent to the wage assignment API application 316.

The wage assignment API application 316 may also assist in communicating with entities and employers 322. In communicating with entities, the employer verifier 314 may obtain the wage assignment compliance level for each entity and employer 322. For example, the wage assignment API application 316 may, via the communication interface 320, send an electronic message, facsimile, email, etc. to an employer 322. Examples of the electronic message include a document package that includes a signed wage assignment of a borrower.

The wage assignment API application 316 may communicate with the employer database 318. The employer database 318 may include one or more employer records 344. Each employer record 344 may include the employer's name 346, identification number 348, address 350, phone number 352, phonetic name 354, wage assignment compliance level 356, and relationship to other employers 358. Other entries and/or information may also be stored in association with each employer 322 such as electronic addresses, facsimile numbers, contact representatives, notes, etc. For example, the name, phone number, and email address of the human resources or payroll representative of the employer may be included in the employer record 344.

The employer's name 346 may be the name of employer. The name 346 may be the legal name of the employer 322 or a commonly known name. The name 346 may be linked to the phonetic name 354. The phonetic name 354 may be a phonetic spelling of the employer's name. Using a phonetic name 354 may compensate for errors, such a spelling errors, entered by the borrower and/or the lender 302. In addition, pattern matching or voice recognition technology may compare the phonetic names to the text names, in order to deduplicate employer records and/or prevent incorrect employer records.

In employer phonetic names 354, the name of the employer provided by a borrower or lender 302 may be converted into a phonetic name 354 by using a text-to-speech application to provide a voice pronunciation. The voice pronunciation may then be converted into a phonetic name 354 and stored in the employer record 354. In addition to compensating for spelling or other errors in an employer's name, uncommonly named entities, entities with symbols or designs in their name, etc., can be accurately entered into the employer's database 318. Furthermore, incorrect duplication of an employer's name is reduced by ensuring that the employer 322 of two different borrowers is identified as the same employer 322, even though the two borrowers may have spelled their employer's name differently.

The identification number 348, for example, may be an employer identification number (EIN). Additionally, the employer database 318 may assign a unique identification number to each employer. The address may be a postal address and/or electronic address, such as an email address. The address may include multiple addresses. For example, the address 350 may identify the address of the physical establishment where the borrower works and the address of the corporate offices where the human resources or payroll department of the employer is located. The phone number 352 may be a phone number, a fax number, and/or an extension number. Preferably, the phone number 352 may be the number of the establishment where the borrower is employed. In this manner, the phone number 352, or a portion thereof, such as the last four digits, may be one of the identifying attributes used to quickly identify an employer 322 in the employer database 318 when querying an employer's wage assignment compliance level 356.

The wage assignment compliance level 356 may specify whether an employer 322 has indicated that they will comply or not comply with a wage assignment agreement. The wage assignment compliance level 356 may specify that an employer 322 has not yet been contacted or that the employer 322 has been contacted but has not yet replied. Various other wage assignment compliance level 356 possibilities are discussed below in greater detail.

The relationship to other employers 358 may indicate whether two employers in the employer database 318 are related. For example, the relationship may be a parent entity (e.g., parent corporation) and a child entity (e.g., subsidiary corporation). As another example, two employers may be sibling entities commonly owned, in whole or in part, under the same parent. By indicating the relationship between a first employer and other employers, inferences regarding the first employer's wage assignment compliance level may be determined based on the known wage assignment compliance levels of one or more of the other employers.

The employer verifier 314 may include a lead application 360. The lead application 360 may employ a lead scoring module 362. The lead application 360 and the lead scoring module 362 may assist the employer verifier 314 in scoring a lead. In some configurations, the lead may receive a high or positive score if the lead has an employer 322 with a favorable wage assignment compliance level 356. The lead may receive a neutral score if the lead does not have an employer in the employer database 318. The lead may receive a negative or low score if the lead's employer has indicated that they will not honor or otherwise apply a wage assignment agreement.

The employer verifier 314 may also include a borrower records database 364. The borrower records database 364 may include information associated with a borrower along with the borrower's signed wage assignment 366. For example, the borrower records database 364 may include a unique borrower identifier along with the borrower's name, social security number, date of birth, address, email, contact information, phone number, employer, job title, etc. It may also include a copy of a signed wage assignment agreement from the lender 302. In this manner, when the employer verifier 314 is required to contact an employer to enforce a wage assignment agreement, the employer verifier 314 may provide a copy of the signed wage assignment 366 to the employer 322.

The information in the borrower records database 364 may be updated as new information from the lender 302 is received at the employer verifier 314. In addition, the borrower information may be returned to the lender 302 upon request for the lender 302.

In some configurations, the employer verifier 314 may receive loan information from a lender 302. For example, this may occur when the lender 302 issues a loan to a borrower. The received loan information may be stored in the borrower records database 364. For example, the loan information may include a loan number, a principal amount, balance, an interest amount, a fee amount, an e-signature name, an e-signature internet protocol (IP) address, an e-signature date/time, and/or the status of the loan, such as the current loan balance or if the loan is current, paid, written-off, in bankruptcy, or inactive. The loan status may also indicate to the employer verifier 314 to initiate the wage assignment process of collecting the borrower's debt from the borrower's employer 322.

Information associated with the borrower's loan may also be updated upon receiving updates from the lender 302. In addition, information associated with the borrower's loan may be reported to the lender 302 upon request.

The system may also include a call center 332 and one or more employers 322. The call center 332 may include a calling application 334 and a communication interface 336. In some configurations, the calling application 334 may make automated calls, emails, and/or faxes to entities. For example, the calling application 334 may call to inquire regarding an employer's wage assignment compliance level. As another example, the calling application 334 may call to notify an employer 322 that a wage assignment agreement is being enforced against a specific borrower. In another configuration, the calling application 334 may provide assistance to an operator who is communicating with an employer 322. For example, the calling application 334 may provide scripts and/or step-by-step instructions for the operator to follow in discussing wage assignments with employers 322. The communication interface 336 may operate similar to other communication interfaces described herein.

The employer 322 may be associated with the employer described in connection with FIG. 2. The employer 322 may be the employer of the borrower. The employer 322 may include employer information 340 and a communication interface 342, which may operate similar to other communication interfaces described herein. The employer information 340 represents information associated with the employer that may be recorded in a corresponding employer record 344 in the employer database 318 located on the employer verifier 314.

FIG. 4 is a flow diagram illustrating a method 400 for creating a wage assignment on an electronic device. In some configurations, the electronic device may be the client 102 described in connection with FIG. 1, or the lender 302 described in connection with FIG. 3 above.

The electronic device may provide 402 a wage assignment agreement template. For example, the electronic device may present the wage assignment agreement template to a user, such as a lending agent, to create a borrower-specific wage assignment agreement. The wage assignment agreement template may be, for example, a webpage, web application, pdf, word document, mobile device application, computer kiosk application, etc. The wage assignment agreement template may also be drafted to accord with applicable law governing wage assignment agreements, as described above. For example, the wage assignment agreement template may specify that the wage assignment agreement is voluntary.

In some configurations, the electronic device may prompt 404 for borrower information to complete the wage assignment agreement template. In addition, the electronic device may verify that the borrower has been informed and understands the wage assignment agreement (e.g., the borrower understands that the wage assignment is voluntary). Further, the electronic device may receive verification that the borrower is not a government employee, including a member of the military.

In some configurations, the electronic device may store the borrower information in a borrower database 306. For instances, the borrower information, or portions thereof, may already be stored in the borrower database 306. As a result, the electronic device may store, retrieve, and/or update the borrower's record in the borrower database 306.

The electronic device may generate 406 a wage assignment agreement 338. The wage assignment agreement 338 may be generated from the wage assignment agreement template. In generating the wage assignment agreement, the electronic device may determine that applicable state and local laws are complied with. In general, wage assignment agreements may be subject to federal law where the wage assignment agreements must comply with rules and regulations issued by the Federal Trade Commission (FTC) and the Fair Debt Collection Practices Act (FDCPA). In some instances, the wage assignment agreement must comply with federal law as well as one or more state laws. The electronic device may receive input, for example from a user, as to which laws apply. Additionally, the electronic device may automatically look up and apply applicable laws when generating a wage assignment agreement template.

In determining if all applicable state and local laws are complied with, the electronic device may verify and/or receive verification regarding a number of requirements, for example, by presenting a checklist to a user, or performing a verification check. In some instances, the electronic device may verify that the wage assignment agreement clearly and inconspicuously states that it is voluntary. For instance, the wage assignment may be required to clearly state: “VOLUNTARY WAGE ASSIGNMENT.” Another requirement may be to specify that the wage assignment agreement is revocable at any time by the borrower, such as reading, “THIS WAGE ASSIGNMENT IS REVOCABLE AT WILL,” and/or titling the document “REVOCABLE WAGE ASSIGNMENT.” In addition, the electronic device may verify that revocation information is included in the wage assignment agreement when the wage assignment agreement is generated.

The electronic device may receive 408 a signed wage assignment agreement 338 from the borrower. After the borrower has read and understood the wage assignment agreement, the borrower may sign the wage assignment agreement 338. The signature may be an electronic signature or another type of signature.

In receiving 408 the signed wage assignment agreement document for the borrower, the electronic device may again verify that the wage assignment agreement 335 is separate from other documents signed by the borrower. This ensures that the borrower is aware of the terms of the wage assignment agreement 338 and that the wage assignment is a separate agreement. The electronic device may also verify that wage assignment agreement 338 clearly states that the wage assignment agreement is not a garnishment, judgment, or anything other than a revocable wage assignment, that the wage assignment agreement 338 is independent and separate from all other documents presented to the borrower, and/or that other requirements are complied with. Signing the wage assignment agreement may be a condition for the borrower to receive a loan.

The electronic device may store 410 the signed wage assignment agreement 338 in a database, such as a customer database 106, a separate wage assignment agreement database, and/or stored on a server 114 or other non-transitory computer readable media. The wage agreement 338 may be stored as a PDF or in another electronic format.

The electronic device may record 412 that the borrower was issued a loan. This may include information associated with the loan, terms of the loan, payment date(s), etc. This information may be recorded on the electronic device in a database, such as the customer database 106.

If the borrower enters into default, the electronic device may receive 414 notification of the borrower's default. Default may occur if the borrower violates one or more conditions of the loan, such as missing a payment. In some cases, the borrower may notify a lending agent that he or she will fail to make a payment or otherwise intends not to honor the loan. In other cases, the electronic device receives 414 notification when it detects that a payment has been missed.

In the event of the borrower's default, the electronic device may determine 416 if the signed wage assignment agreement 338 is stored in the database and if the wage assignment agreement is still valid. In some cases, the borrower may have revoked the voluntary wage assignment agreement. Here, the wage assignment agreement 338 may be removed from the database or an indication of the revocation may present. For example, the client 102 may notify the server 114 of the revocation via an API call.

If the wage assignment agreement 338 is not stored in the database or is not valid, the electronic device may attempt to obtain 418 the debt owed by the borrower through traditional means. For example, the lending agent may attempt to directly collect the debt from the borrower, employ a collection agency to collect the debt, or commence a garnishment or other legal action to collect the debt.

The electronic device may notify 420 the server 114 that the borrower has defaulted. In conjunction with the notification, the electronic device may send the wage assignment agreement to the server 114. For example the electronic device may retrieve the stored wage assignment agreement 338 from the borrower database 306 and transmit a copy to the server 114.

The electronic device may receive 422 payment for the debt. The payment may be made, for example, from the borrower, the employer, and or from the server 114 that collected the debt from the employer via the wage assignment agreement. The payment may be a full or partial payment of the balance of the debt owed by the borrower.

In some configurations, payment information may be reported to the server 114 wage assignment agreement API application 116. For example, a client 102 may report the payment amount, date, method, type, etc. in connection with the loan number and/or borrower information. Additionally, once payment information is reported, inquiries may be made to the server 114 regarding the balance and repayment state of an open account or loan.

Upon full payment of the loan, the electronic device may close 424 the debt. The electronic device may also update the record associated with the loan stored in the database. For example, the electronic device may update the records associated with the borrower in the borrower database 306.

FIG. 5 is a flow diagram illustrating a method 500 for receiving a wage assignment request on an electronic device. In some configurations, the electronic device may be the server 114 described in connection with FIG. 1 or the employer verifier 314 described in connection with FIG. 3.

The electronic device may receive 502 a request for information regarding an employer. The request may be sent by another electronic device, such as a client 102 or a lender 302. For example, the client 102 may request information regarding the wage assignment compliance level of the employer. The client 102 may use this information to determine whether to issue credit or make a loan to a potential borrower. In some configurations, communications between the electronic device and the client 102 may be encrypted.

The electronic device may obtain 504 employer information from the request. For example, the electronic device may parse the request to extract various pieces of information, such as the employer's name, identification number, address, phone number, notes, email address, etc. Additional pieces of information may include secondary phone numbers, the employer's human resources, or payroll department contact information, etc. In some configurations, the electronic device may reject the request if it cannot obtain a minimum amount of employer information.

The electronic device may determine 506 if the employer is located in a database. For example, the database may be an entity database 118 located on the server 114. The electronic device may use information obtained from the request to identify the employer. In some configurations, the electronic device may only need to identify one unique characteristic of the employer from the request. For example, the electronic device may identify the 10-digit phone number 352 of the employer from the request and may lookup the employer record 344 based on the phone number 352, or a portion thereof (e.g., the last seven or four digits). As another example, the electronic device may attempt to identify the employer based on multiple potentially unique characteristics, such as EIN, phone number, address, etc. The electronic device may perform the identification of the employer based on potentially unique characteristics in parallel or serially. For instance, the electronic device may match a threshold number of digits in the employer's phone number until a potentially unique match is identified. The threshold number may be increased based on a determined assurance percentage or identification accuracy metric, for instance, until there is only a single match.

In some configurations, if the employer is not in the database, the electronic device may contact 508 the employer with a wage assignment agreement request. For example, the electronic device may notify a call center 332 to contact the employer with a wage assignment agreement request regarding the employer's wage assignment compliance level. As another example, the electronic device may send an email to the employer with a wage assignment agreement request.

The electronic device may receive 510 a reply from the employer. The reply may indicate the employer's wage assignment compliance level. For example, the reply may indicate that the employer will, or will not comply with a wage assignment agreement. As another example, the reply may indicate that the request is pending or that compliance is not possible, for example because the law does not permit it. The reply may be in the same form or a different form as the employer was contacted by the electronic device. The electronic device may add 512 the employer record to the database.

In one configuration, if a period of time has elapsed without receiving a reply to the wage assignment agreement request, the electronic device may indicate that the employer has been contacted but has not responded. In some configurations, the employer database may be maintained upon attempts to establish one or more wage assignments with one or more employers. For example, the electronic device may record in the database the number of past contact attempts extended to the employer.

At any time, the server may update, modify, remove, etc., the entry in the employer database 318 based on information obtained about the employer associated with the employer record 344.

In some configurations, the electronic device may optionally send 514 a response to the client 102 indicating that the employer is unresponsive and/or that the employer's wage assignment compliance level is unknown.

If the employer is located in the database, for example, in an employer record 344, the electronic device may determine 516 if the employer will honor and comply with a wage assignment agreement. If the employer will comply with a wage assignment agreement, the electronic device may send 518 a response to the client indicating the employer's compliance. If the employer will not comply with a wage assignment agreement, the electronic device may respond 522 to the client indicating that the employer will not comply with a wage assignment agreement.

In the case that employer record 344 does not indicate a wage assignment compliance level for an employer, the electronic device may send 520 a response to the client indicating that no record of the wage assignment compliance level is available and/or that other risk assessment procedures may be required. Additionally, the electronic device may optionally attempt to re-contact 524 the employer to obtain a response from the employer regarding their wage assignment compliance level. Upon receiving a response from the employer, the electronic device may again determine 516 whether the employer will comply with a wage assignment agreement. Alternatively, in some configurations, if the employer has not responded after a pre-determined time or number of attempts, the electronic device may characterize the employer as non-compliant.

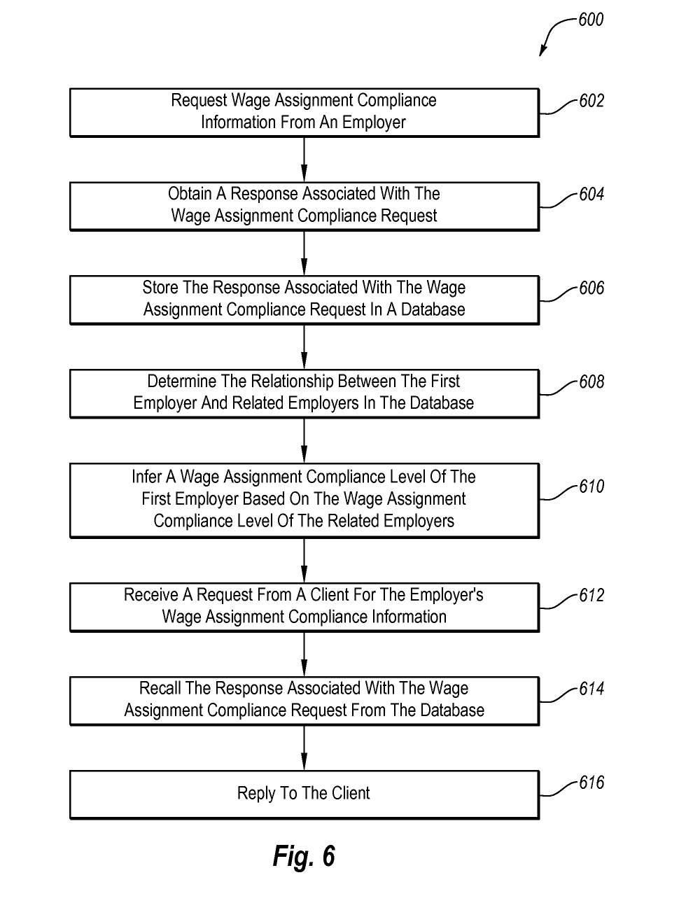

FIG. 6 is a flow diagram illustrating a method 600 for recording data in association with a wage assignment agreement on an electronic device. The electronic device may be the server 114 described in connection with FIG. 1 or the employer verifier 314 described in connection with FIG. 3.

The electronic device may request 602 wage assignment compliance information from an employer. For example, the electronic device may prepare and/or send a message to the employer. The message may be a letter, facsimile, electronic message, etc. In some configurations, the electronic device may send a notification to a call center 332 to contact the employer to determine the employer's wage assignment compliance level.

The electronic device may obtain 604 a response associated with the wage assignment compliance request. The response may indicate the wage assignment compliance level of the employer. For example, the response may indicate that the employer will honor a wage assignment agreement. Alternatively, the response may indicate that the employer will not honor a wage assignment agreement made by one of its employees (e.g., a borrower).

The electronic device may store 606 the response associated with the wage assignment compliance request in a database. For example, the electronic device may store the response in an employer database 318.

In some configurations, the electronic device may determine 608 the relationship between the employer and other employers in the database. The electronic device may determine that two employers in the database are owned by the same entity, part of the same franchise, have a similar parent, etc. For example, a borrower may work at a specific fast-food restaurant that is part of a nationwide chain. The database may include records for other locations that are also part of the same nationwide chain. Each record may specify if the location is independently owned and operated or if the parent corporation operates the location. In this manner, the electronic device may determine 608 that two employers are related because they are owned and operated by the same parent entity.

The electronic device may infer 610 a wage assignment compliance level of a first employer based on the wage assignment compliance level of a related employer. The electronic device may infer 610 that the first employer will comply with a wage assignment agreement based on one or more sibling employers also complying. Similarly, the electronic device may infer 610 that the employer will refuse compliance based on the parent company refusing compliance. Further, the electronic device may make an inference based on the number of related employers who have previously complied versus related employers who have refused compliance. For example, if the database includes records from thirty employers who belong to a nationwide retail store chain, and if twenty-five of the thirty employers have records that indicate compliance, the electronic device may infer compliance of a new employer that also belongs to the nationwide retail store chain.

The electronic device may base the inferred compliance on a number of factors, such as the wage assignment compliance level of related employers, whether the employer is independently owned, the type of business the employer has, the size of the employer, the length of time the employer has been in business, the third-party payroll processor of the employer or the employer's related employers, etc. The electronic device may improve its inference ability by filtering out (e.g., select or isolate) similar related employers, such as employers all owned by the same franchise owner, employers by geographic location, etc. For example, the electronic device may select all Subway restaurants owned by the same owner from all of the Subway restaurants located in the employer database 318. As another example, the electronic device may isolate and select only Subway restaurants located in a specific state or within a threshold radius. In this manner, the electronic device may infer, with a higher probability, the wage assignment compliance level of a similar newly added employer by matching it to similar employers already in the database.

In some cases, the electronic device may make an inference, before contacting the employer. Once the employer has been contacted and the employer's wage assignment compliance level has been ascertained, the electronic device may update the employer's record in the database. The electronic device may then record if the inference made was accurate or not. The electronic device may improve the accuracy of further inferences based on tracked statistics, such as regarding inferred wage assignment compliance levels as compared to actual wage assignment compliance levels.

The electronic device may receive 612 a request from a client 102 for the wage assignment compliance level of an employer. The electronic device may receive 612 a request from the client 102 at any time. For example, the electronic device may receive 612 a request from the client 102 before the electronic device has requested 602 wage assignment compliance information from an employer.

The request from the client 102 may query the electronic device for an employer's wage assignment compliance level. If the electronic device has the employer stored in the database, the electronic device may recall 614 the response associated with the wage assignment compliance request from the database. Alternatively, the electronic device may request 602 wage assignment compliance information from the employer.

The electronic device may reply 616 to the client 102. The reply may include the wage assignment compliance level of the employer. For example, the reply may indicate that the employer has previously complied with and/or honored a wage assignment agreement by repaying a borrower's debt; the reply may indicate that the employer has agreed to comply, but has not yet enforced a wage assignment agreement; the reply may indicate that the employer has refused to enforce a wage assignment agreement when presented with one; the reply may indicate that the employer has indicated that they will not enforce a wage assignment agreement; or the reply may indicate the employer has not responded to the electronic device. Other replies may also be given. For example, the electronic device may reply 616 to the client with an inferred wage assignment compliance level for the employer. This may be accompanied by an inference confidence level, or an indication of how accurate the inference may be. The client 102 may use this information in determining whether to issue a loan to the borrower.

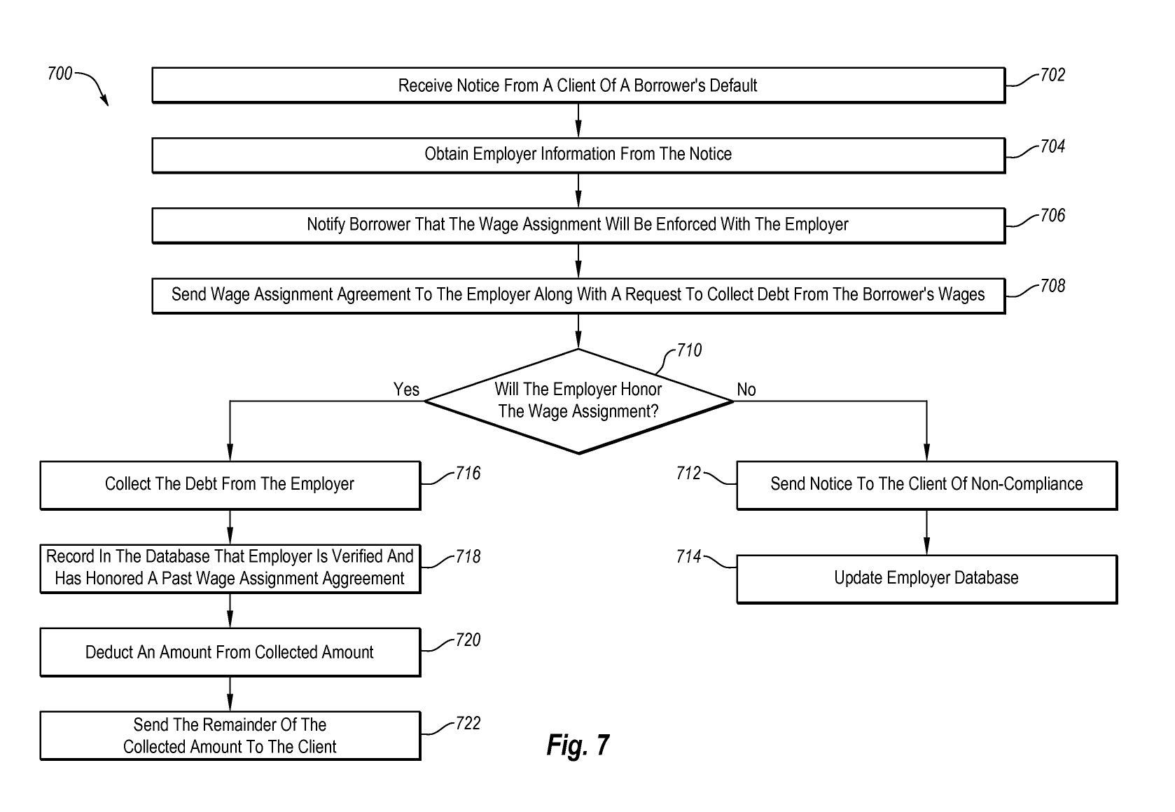

FIG. 7 is a flow diagram illustrating a method 700 for employing automated wage assignments on an electronic device. The electronic device may be the server 114 described in connection with FIG. 1 or the employer verifier 314 described in connection with FIG. 3.

The electronic device may receive 702 notice from a client of a borrower's default. The notice may include a copy of the wage assignment agreement signed by the borrower. The electronic device may obtain 704 information from the notice. For example, the electronic device may identify the name of the borrower and/or employer and other information about the employer. This borrower and/or employer information may be parsed from the notification.

The electronic device may notify 706 the borrower that the wage assignment agreement will be enforced with the employer. For example, the electronic device may notify the borrower that the wage assignment agreement will be sent to the borrower's employer if payment is not obtained. In some approaches, the electronic device may notify a call center 332 to call the borrower. The electronic device may message, email, mail a letter, and/or text the borrower to inform the borrower that the wage assignment agreement is being sent to their employer. In some cases, multiple notifications may be sent. For example, the electronic device may send three emails or texts informing the borrower that failure to pay will result in the wage assignment being sent to his or her employer. In this example, each of the messages sent to the customer may be different and may be generated by the electronic device and automatically sent.

The electronic device may send 708 the wage assignment agreement 338 to the employer along with a request for the employer to collect the debt from the borrower's wages. For example, the electronic device may email and/or fax a document package including the wage assignment agreement 338 to the employer. In some configurations the electronic device may employ a third party to send the document package or may send it directly. Examples of a third party that may be employed to send the document package include an online fax service, an online email service, a cloud computing based phone, fax, and email system, etc.

The request to collect the debt may include the remaining principal amount of the loan, balance, interest, and/or fees. The request to collect the debt may specify that the employer is to withhold a particular amount from the borrower's paycheck and forward that amount to the lender 302, such as, for example, through the employer verifier 314. Sending 708 the request and wage assignment agreement to the employer may be done automatically, for example, by electronic message or facsimile. In some configurations, the electronic device may verify that the employer has received the wage assignment agreement. For instance, the electronic device may request that the call center 332 contact the employer to verify that it has received the wage assignment agreement.

The electronic device may determine 710 if the employer will honor the wage assignment agreement. If the employer does not or will not pay back the borrower's debt, the electronic device may send 712 notice to the client of non-compliance. The electronic device may then update 714 the employer database indicating that the employer has refused to comply with a wage assignment agreement.

If the employer does honor the wage assignment agreement, then the employer will deduct the debt owed from the borrower's wages. The electronic device may verify that the amount requested from the employer does not exceed a maximum amount, such as a maximum deductible percentage set by law. In this case, the electronic device may break the payment requests into smaller amounts below the maximum allowed amount.

If the employer pays the borrower's debt, or a portion thereof, the electronic device may collect 716 the owed amount, or a portion thereof, from the employer. The employer may send the collected debt via a check, an electronic check, wire transfer, direct deposit, etc. The electronic device may then record 718 in the database that the employer is verified and has honored wage assignment agreements. Such records may be used for the other purposes described herein.

The electronic device may deduct 720 an amount or percent from the collected amount. The amount deducted from the received payment may be a percentage, flat rate, or fee agreed upon for collecting payment from the employer. For example, the client 102 and the server 114 may agree upon an amount to be deducted from payments received from employers in order to compensate the server 114 operator for the service provided to the client 102 by making it easier for the client 102 to obtain payment of debts from borrowers and their respective employers. The electronic device may send 722 the remainder of the collected amount to the client 102.

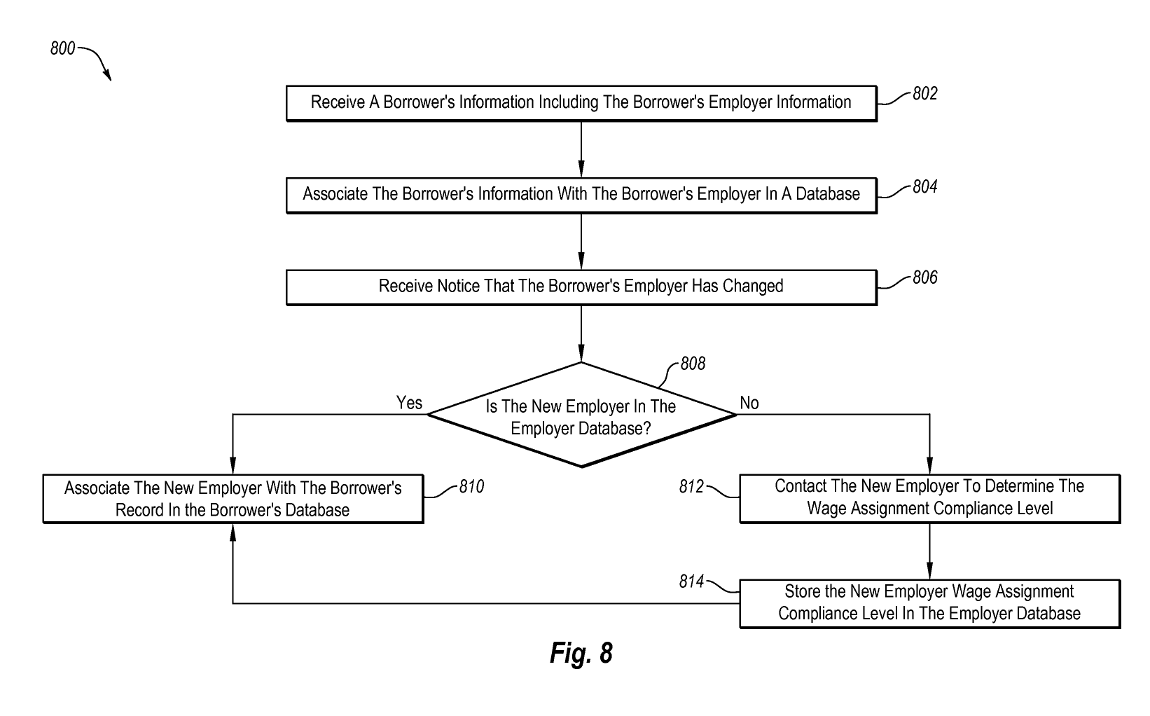

FIG. 8 is a flow diagram illustrating a method 800 for associating a borrower with an employer. The method 800 may be performed by an electronic device, such as the server 114 described in connection with FIG. 1 or the employer verifier 314 described in connection with FIG. 3.

The electronic device may receive 802 a borrower's information, including the borrower's employer information. The borrower's information may be obtained as described previously. For example, the electronic device may receive borrower information and employer information from a client 102. The borrower information may include the borrower's name, social security number, date of birth, address (e.g., physical address and email), contact information, phone number, employer, job title, etc.

The electronic device may associate 804 the borrower's information with the borrower's employer in a database. For example, the electronic device may have a database, such as a borrower records database 364 that matches the borrower with the borrower's employer. In some cases, the borrower may be associated with his or her employer by linking the borrower to an employer record 344 located in an employer database 318.

The electronic device may receive 806 notice that the borrower's employer has changed, for example, to a new employer. For instance, the client 102 may notify the electronic device that the borrower has changed employers. As another example, a borrower's former employer may notify the electronic device that the borrower is no longer employed by the former employer. Upon receiving the notice, the electronic device may determine 808 if the borrower's new employer is in the employer database.

In some configurations, the electronic device may periodically verify that the borrower still works for the employer on record. For example, the electronic device may request the call center 332 contact the employer quarterly to verify the borrower's employment status. The frequency of the verification may depend on the duration and/or amount of the loan, for example.

If the new employer is located in the employer database on the server 114, the electronic device may associate 810 the borrower with the new employer. If the new employer is not located in the employer database, the electronic device may contact 812 the new employer and update 814 the employer database, as described above. For example, the electronic device may perform the necessary steps to obtain the wage assignment compliance level of the new employer.

FIG. 9 is a flow diagram illustrating a method 900 for assessing lead information using wage assignments. An electronic device may perform the method 900, such as on a client 102, a server 114, or a combination thereof. As another example, the method 900 may be performed by lender 302, employer verifier 314, or a combination thereof.

The electronic device may obtain 902 one or more leads. The leads may be received from a second electronic device. For example, data including hundreds of leads could be sent to the electronic device. In some instances, a third party may send the leads to the electronic device. Alternatively, the electronic device may generate the leads. The electronic device may sort and filter the leads according to various criteria.

The electronic device may select 904 from the one or more leads that have a credit score below a threshold criteria. For example, the electronic device may select leads that have a credit score below a threshold value. These leads may be potential borrowers that generally would not be able to get a loan from even a sub-prime lender.

The electronic device may obtain 906 employer information for each lead that has a credit score below the threshold criteria. This may be performed as described above.

The electronic device may determine 908, for each selected lead, whether the lead's employer will comply with a wage assignment agreement. The electronic device may look up the lead's employer in an employer database 318 and check if the lead's employer will comply with a wage assignment agreement. In some configurations, for leads that have no wage assignment information available, the electronic device may infer 910 a wage assignment compliance level, as described above.

Based on searching employer records 344 in the employer database 318, the electronic device may further select 912 leads that have employers who will comply with a wage assignment agreement. The further selected leads may be leads that have employers that have confirmed compliance with payment, indicated compliance, and/or employers with inferred compliance.

In some configurations, the electronic device may provide an indication 914 of the further selected leads. The electronic device may provide the indication to the client 102, another electronic device, or a user.

In some configurations, such as if the leads are being bid upon in an auction, the electronic device may optionally submit 916 a bid for one or more of the further selected bids. As described above, a leads provider may obtain information from potential borrowers and offer the potential borrowers' information via an auction to lenders looking to solicit potential borrowers.

The electronic device may submit a minimum or near minimum amount needed to win the bids. For example, if bids for each lead range from $1 to $130, the electronic device may place a bid closer to the $1 range per lead. In this manner, the electronic device may obtain leads that are collateralized by their employer for a minimum amount, even though these leads have poor credit scores and may generally be considered undesirable leads by others using traditional analytical methods to evaluate leads. In other words, this approach increases the pool of potential borrowers that may be offered loans by lenders.

The electronic device may determine that these leads have collateralized employers based on the employer records 344 in the employer database 318. These leads would otherwise not have been bid upon because they pose too great a risk to lenders due to their low credit scores determined by traditional methods, such as judging and purchasing leads based on a borrower's credit histories alone. Thus, validating leads based on their employer's willingness to accept a wage assignment, rather than solely based on their credit history allows lending agents to identify valuable leads that would otherwise be overlooked by other lending agents that identify customer leads based solely on credit history. Also, validating leads based on an employer's willingness to accept a wage assignment allows lending agents to make loans to borrowers.

As an example, 80,000 leads may be sent to the electronic device each day that may be bid upon. Of those 80,000 leads, 35,000 leads may be traditionally ignored because their credit scores are inadequate. However, of those 35,000 leads, 500 may have inadequate credit scores, but may have employers that will honor wage assignment agreements. Thus, the electronic device may determine that these 500 are potential borrowers, and may bid for these 500 leads at a minimum price.

In some configurations, the systems and methods described herein may be combined with traditional credit check methods in winning and obtaining leads who become borrowers.

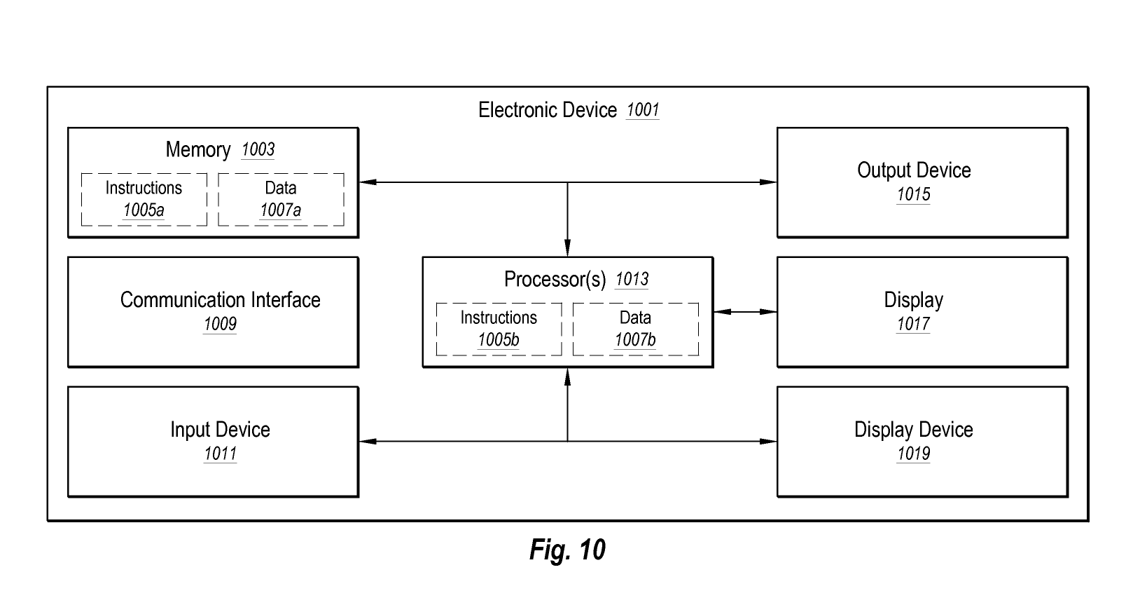

FIG. 10 illustrates various components that may be utilized on an electronic device 1001. The electronic device 1001 may be the client 102 or client 114 described in connection with FIG. 1, or the lender 302, employer verifier 314, or call center 332 described in connection with FIG. 3. The illustrated components may be located within the same physical structure or in separate housings or structures. The electronic device 1001 may also be configured similarly to one or more of the electronic devices described above in connection with FIGS. 4-9.

The electronic device 1001 may include one or more processor(s) 1013 and memory 1003. The memory 1003 may include instructions 1005a and data 1007a. The processor 1013 controls the operation of the electronic device 1001 and may be, for example, a microprocessor, a microcontroller, a digital signal processor (DSP), or another known device. The processor 1013 may be in electronic communication with the memory 1003. The processor 1013 typically performs logical and arithmetic operations based on program instructions 1005b and/or data 1007b it loads from the memory 1003.

The electronic device 1001 typically may include one or more communication interface(s) 1009 for communicating with other electronic devices. The communication interface(s) 1009 may be based on wired communication technology, wireless communication technology, or both. Examples of different types of communication interfaces include a serial port, a parallel port, a universal serial bus (USB) port, an Ethernet adapter, an IEEE 1394 bus interface, a small computer system interface (SCSI) bus interface, an infrared (IR) communication port, a Bluetooth wireless communication adapter, a network storage device, an external hard drive, an optical drive (e.g., compact disc (CD) drive, digital video disc (DVD) drive, Blu-ray drive, etc.) and so forth.

The electronic device 1001 typically may include one or more input devices 1011. Examples of different kinds of input devices 1011 include a keyboard, mouse, microphone, remote control device, button, joystick, trackball, touchpad, touchscreen, lightpen, camera, and/or other input device. The input device 1011 may receive input from another device and/or from a user of the electronic device 1001. The input device 1011 may comprise multiple devices, blocks, and/or modules that the server or client may use to receive information. For instance, an input device 1011 may be an Ethernet card that may receive information from another computing device connected to a network. In another example, the input device may be a computer mouse that may be used by the electronic device 1001 to detect user interaction such as a “click” on an icon and/or translation of a cursor.

The electronic device 1001 typically may include one or more output devices 1015. Examples of different kinds of output devices 1015 include displays, touchscreens, projectors, speakers, tactile devices, network cards, wireless transmitters, infrared transmitters, lights, etc. The output device 1015 may output, transmit, send, display, project, emit, and/or convey information to another device and/or to a user of the electronic device 1001. For instance, the output device 1015 may be a monitor that can display information (e.g., images) to a user. In another example, the output device 1015 may be a network card that can transmit information to another computing device connected to a network. In some configurations, the output device 1015 may display a graphical user interface (GUI) to facilitate user interaction. For example, the electronic device 1001 may display a window with icons that a user may interact with using a keyboard and/or mouse.

One specific type of output device 1015 that may typically be included in a electronic device 1001 is a display device 1019. Display devices 1019 used with configurations disclosed herein may utilize any suitable image projection technology, such as a light-emitting diode (LED), gas plasma, liquid crystal display (LCD), cathode ray tube (CRT), electroluminescence, or the like. A display controller 1019 may also be provided for converting data stored in the memory into text, graphics, and/or moving images. FIG. 10 illustrates only one possible configuration of an electronic device 1001. Various other architectures and components may be utilized.

In the above description, reference numbers have sometimes been used in connection with various terms. Where a term is used in connection with a reference number, this may refer to a specific element that is shown in one or more of the figures. Where a term is used without a reference number, this may refer generally to the term without limitation to any particular figure.

The term “determining” encompasses a wide variety of actions and, therefore, “determining” can include calculating, computing, processing, deriving, investigating, looking up (e.g., looking up in a table, a database or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of non-transitory computer-readable statements. For example, the terms “instructions” and “code” may refer to one or more programs, routines, sub-routines, functions, procedures, etc. “Instructions” and “code” may comprise a single computer-readable statement or many computer-readable statements.

The term “computer-readable medium” refers to any available medium that can be accessed by a computer or processor. By way of example, and not limitation, a computer-readable medium may comprise RAM, ROM, EEPROM, CD-ROM or other optical disk storage, magnetic disk storage or other magnetic storage devices, or any other medium that can carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. It should be noted that a computer-readable medium may be non-transitory and tangible.

Software or instructions may also be transmitted over a transmission medium. For example, if the software is transmitted from a website, server, or other remote source using a coaxial cable, fiber optic cable, twisted pair, digital subscriber line (DSL), or wireless technologies, such as infrared, radio, and microwave, then the coaxial cable, fiber optic cable, twisted pair, DSL, or wireless technologies, such as infrared, radio, and microwave, are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the systems, methods, and apparatus described herein without departing from the scope of the claims.

What is claimed is:

1. A method comprising:
obtaining a wage assignment compliance level from an entity;
storing the wage assignment compliance level in a database;
recalling, by at least one processor, the wage assignment compliance level from the database in response to a request; and
sending a response to the request indicating the wage assignment compliance level of the entity.

2. The method of claim 1, wherein the entity is an employer.

3. The method of claim 1, further comprising receiving a query regarding the entity's wage assignment compliance level.

4. The method of claim 1, further comprising determining from the wage assignment compliance level whether the entity will comply with the wage assignment.

5. The method of claim 1, wherein the at least one processor is located on a server.

6. The method of claim 1, further comprising receiving a request from a client.

7. The method of claim 6, wherein the request from the client comprises information identifying the entity.

8. The method of claim 7, wherein the information identifying the entity includes one of an identification number, name, address, and phone number.

9. The method of claim 6, further comprising sending the wage assignment compliance level to the client.

10. The method of claim 5, further comprising receiving information associated with a borrower from the client.

11. The method of claim 10, wherein the borrower is an employee of the entity.

12. The method of claim 11, wherein the response further indicates one of: the entity will comply with the wage assignment, the entity will not comply with the wage assignment, and the entity is non-responsive as to if it will comply with the wage assignment.

13. A method comprising:
receiving a request for information regarding an entity;
determining, using at least one processor, if the entity is located in a database;
determining whether the entity will comply with a wage assignment, if the entity is located in the database; and
sending a response indicating the entity's compliance level with the wage assignment.

14. The method of claim 13, wherein the request for information regarding the entity further comprises a request for whether the entity will comply with the wage assignment.

15. The method of claim 13, further comprising obtaining information about the entity from the request.

16. The method of claim 13, wherein the wage assignment is associated with the entity and with a borrower identified in the request.

17. The method of claim 13, wherein the entity is a payroll entity.

18. The method of claim 13, further comprising:
recording that wage assignment information associated with the entity is not located in the database, if the entity is not located in the database;
requesting wage assignment compliance information from the entity; and
storing the response of the wage assignment compliance information request in the database.

19. A method comprising:
receiving information regarding a first entity's wage assignment compliance level in response to a wage assignment compliance request;
inferring, by at least one processor, the wage assignment compliance level of the first entity based on a second entity's wage assignment compliance level;
storing the inferred wage assignment compliance level for the first entity.

20. The method of claim 18, wherein the first entity is related to the second entity
